(19) United States
(12) Patent Application Publication
(10) Pub. No.: US 2012/0091185 A1
(43) Pub. Date: Apr. 19, 2012

(54) IN-PROCESS WELD GEOMETRY METHODS & SYSTEMS

(75) Inventors: I. Charles Ume, Atlanta, GA (US); Matthew Douglas Rogge, Williamsburg, VA (US)

(73) Assignee: Georgia Tech Research Corporation, Atlanta, GA (US)

(21) Appl. No.: 12/906,859

(22) Filed: Oct. 18, 2010

(51) Int. Cl. B23K 20/10

(52) U.S. Cl. 228/1.1; 228/102

(57) ABSTRACT

Some embodiments include in-process welding devices to compensate for error associated with detected weld penetration depth. Exemplary devices can generally include an ultrasonic energy source, an ultrasonic receiving sensor, and a controller. The ultrasonic energy source can be disposed to generate ultrasonic energy through a first specimen being welded to a second specimen. A weld seam can be used to join the first specimen to the second specimen. The ultrasonic sensor can be disposed on an opposite side of the weld seam from the ultrasonic energy source, and configured to detect ultrasonic energy propagated from the first specimen side of the weld seam to the second specimen side of the weld seam. The controller can be disposed to receive data from the ultrasonic sensor, configured to determine time of flight signal data corresponding to arrival of the ultrasonic energy detected by the ultrasonic sensor, and configured to compare the determined time of flight signal data to a model to compute error associated with the determined time of flight signal data due to a dynamic welding environment. Other aspects, embodiments, and features are claimed and described.

### TECHNICAL FIELD

Embodiments of the present invention relate generally to welding and more particularly to in-process weld geometry methods and systems that use error compensation techniques for weld corrections.

### BACKGROUND

Weld quality is a major concern for a variety of manufacturing settings. Insufficient quality can lead to part failure and safety concerns so it is imperative to accurately determine and control weld quality. Penetration depth is a key geometric factor in determining weld quality.

One common penetration depth measurement method is to perform a “cut check” and visually inspect the cross section of the weld. Using this and other destructive methods, only a subset of parts can be measured. This leads to wasted material, low throughput, and low confidence in weld quality for a given lot of components. Much effort has been put forward to measure this quantity in a non-destructive manner.

A recent development in non-destructive penetration depth measurement is the use of non-contact laser ultrasound generation. Ultrasound is generated on one side of the weld and received on the other. Weld penetration depth is then determined from the time of flight of the ultrasonic wave. This technique has been shown to be accurate at room temperature but at elevated temperatures present during welding, the technique can yield false measurements of penetration depth. False measurements are generally caused by a welding arc's introduction of electrical and heat energy during the welding process. As a result, current in-process depth penetration measurement systems possess drawbacks.

Improved methods and systems that provide solutions at higher weld temperatures and that account for electrical energy due to welding arcs are needed. Embodiments of the present invention are directed to in-process weld geometry methods and systems that provide solutions capable of measuring weld depth during high process temperatures.

### SUMMARY OF EXEMPLARY EMBODIMENTS

Welding is a key technique for joining structural members. Practiced in a wide array of industries, welding is ubiquitous in building construction, automotive manufacturing, oil platform and pipeline construction, bridges and aerospace structures. Weld quality is dependent on many factors such as weld reinforcement width and height, weld penetration depth, number of porosity and weld bead microstructure.

Weld penetration depth is of key concern because it directly contributes to the load bearing capabilities of the welded structure. Ultrasonic techniques have been used to measure weld penetration depth for quite some time. Traditionally, transducers (e.g., angle beam Piezoelectric Transducers (PZTs) and phased arrays) are used to measure weld penetration depth. In most applications, penetration depth is measured after either the entire weld or a section of the weld is completed. While this ensures the structure is manufactured to specifications, any mistakes that are made must be corrected via costly rework. In addition, in many cases a trained technician performs the inspection by hand. Online weld penetration measurement is needed to measure penetration depth in real time for monitoring and in order to be able to realize real time welding control.

Online measurement of weld quality permits feedback to either an operator or an automatic weld quality controller. Through-arc sensing involves modeling the welding arc and electrode as resistors in series. Irregularities in the welding process can be detected by monitoring the voltage and current in this circuit. The main disadvantage of this method is that the weld geometry and defects cannot be determined directly, only disturbances of the welding process. There are two main advantages of through ar-sensing of current and voltage: the system is non-contact and economical.

As the welding process is characterized by high temperature and thermal gradients, this information can be used to infer weld geometry. One inspection technique uses an infrared camera to capture the thermal profile on the surface(s) of the material. The temperature profile at the top surface of the work piece can be used to determine weld pool geometry. By measuring the thermal profile on the top and bottom surfaces, the thermal gradient can be used to calculate the penetration depth of the weld. Fitting numerical results to the measured temperature profile(s) can be used to estimate internal material temperatures. Once the internal temperatures are estimated, the penetration depth may be determined. Advantages of this method are that it is non-contact, can measure weld bead geometry directly and uses readily available sensors. The major disadvantages of this method are its inability to measure internal weld defects.

The machine vision method uses an infrared camera and image processing techniques to determine the weld pool geometry. The weld pool geometry is then used to determine weld geometry. Machine vision systems can also be used very effectively for seam tracking. Weld reinforcement height can also be measured by painting a laser line across the weld bead. By recording the deviation of the line, the weld reinforcement height can be determined. Other structured light techniques may also be used. This method has advantages similar to the thermal distribution sensor. It is non-contact, uses inexpensive, readily available sensors and can measure the weld pool shape directly. Defects internal to the weld cannot be detected, but they can be predicted by monitoring the weld pool shape.

Ultrasonic techniques have been developed to measure weld penetration depth during welding. Typically, the Time of Flight (ToF) of the wave to travel from the source to the receiver is measured and related to the penetration depth. Phased arrays consisting of many EMAT elements have been used to measure the location of cracks caused by lack of fusion and incomplete penetration. The phased array generates and steers the wave towards the weld seam and then receives the reflection. While effective, costly power amplifiers are needed for generation of ultrasound by EMATs. Laser generation of ultrasound has been shown to be an effective noncontact means of generating ultrasound even when the samples are at elevated temperatures. The output of a high power pulsed laser is directed to the surface of the sample via optics such as optical fibers or beam steering mirrors. In order to direct the sound towards the weld, phased arrays have been implemented in which the laser light is transmitted through fibers of varying lengths to create the time delays between each of the elements in the array.

Ultrasonic techniques have been shown to be very accurate at room temperature. When used during welding, error is introduced due to electrical noise from the welding arc and changes in wave velocity due to elevated temperatures. The effect of elevated temperatures has been modeled using finite element models. The technique performs very well, but assumes constant welding parameters. If welding parameters are changing quickly, the supporting assumption may no longer be valid. In addition, significant computation is needed for each welding setup and material.

To compensate for error cause by elevated welding temperatures, embodiments of the present invention include modeling errors as a nonlinear dynamic process. The model can predict error for varying welding parameters. The model is preferably built based on experimental data with minimal computation (relative to costly finite element simulations) for a new configuration. In a currently preferred embodiment, a neuro-fuzzy modeling paradigm is utilized because of its capability to effectively model nonlinear processes and ease of training. For example, Adaptive Neuro-Fuzzy Inference System (ANFIS) can be used to train a Takagi-Sugeno form fuzzy inference system.

Broadly speaking embodiments of the present invention include an in-process welding device to compensate for error associated with detected weld penetration depth. The device can generally comprise an ultrasonic energy source, an ultrasonic sensor, and a controller. The ultrasonic energy source can be disposed to generate ultrasonic energy through a first specimen being welded to a second specimen, wherein a weld seam is used to join the first specimen to the second specimen. The ultrasonic sensor can be disposed on an opposite side of the weld seam from the ultrasonic energy source, the ultrasonic sensor configured to detect ultrasonic energy propagated from the first specimen side of the weld seam to the second specimen side of the weld seam. The controller can be disposed to receive data from the ultrasonic sensor. The controller can also be configured to determine time of flight signal data corresponding to arrival of the ultrasonic energy detected by the ultrasonic sensor. The controller can also be configured to compare the determined time of flight signal data to a model to compute error associated with the determined time of flight signal data due to a dynamic welding environment.

Embodiments of the present invention can also include additional features. For example, the controller can be configured to utilize the computed error to adjust welding parameters in the dynamic welding environment based on the computed error. The controller can also be configured to utilize the computed error to determine an estimated time of flight value for use in estimating weld penetration depth. The controller can be configured to vary at least one of location of the first and second specimens, laser parameters, and weld parameters in the dynamic welding environment based on the computed error. The ultrasonic energy source comprises at least one of a pulsed laser, laser, laser phase array, and an EMAT. The ultrasonic sensor can comprise at least one of an electro-magnetic acoustic transducer, a piezo-electric transducer, laser inferometer, and vibrometer. The controller can receive ultrasonic energy from the ultrasonic energy source for use in instructing the ultrasonic sensor to detect ultrasonic energy propagated through the first specimen. The model used to estimate error can be based on a neuro-fuzzy based dynamic data model based at least partially on wire feed rate history. The model can also be trained at least partially based on test samples that have been characterized via destructive testing.

Embodiments of the present invention also include in-process welding methods to compensate for error occurring during welding processes. These methods can generally comprise preparing an error compensation model to account for error introduced during a dynamic welding environment; sensing on-line time of flight data proximate one or more welding specimens during a dynamic welding environment with one or more data sensors; and providing estimated time of flight data based on the error compensation model and the sensed on-line time of flight data. Methods can also include subtracting estimated time of flight error based on the error compensation model from the sensed on-line time of flight data to provide the estimated time of flight data. The error compensation model is a neuro-fuzzy compensation model. Methods can also include altering welding system parameters in response to the estimated time of flight data.

Method embodiments can also include additional features. For example, the method can include providing an ultrasonic energy source to direct ultrasonic energy toward a welding specimen to generate ultrasonic energy to be sensed by one or more sensors. The one or more sensors being located on an opposing side of a weld seam from the ultrasonic energy source. The error compensation model can be at least partially dependent upon wire feed rate of a welder. Method embodiments can also include analyzing a previously welded specimen to determine actual, off-line time of flight data and using said off-line time of flight data to generate the error compensation model.

Embodiments of the present invention can further include in-process welding devices (or systems) to compensate for error associated with detected weld penetration depth. Such a device can generally comprise a welding station and an ultrasonic energy source, and a controller. The welding station can comprise a welding specimen, a welding torch, an ultrasonic energy source, and an ultrasonic energy transducer. The welding specimen can have a welding seam for joining a first specimen and a second specimen. The ultrasonic energy source can be disposed to emit ultrasonic energy toward the first specimen for creating a wave energy that travels through the welding seam toward the second specimen. The ultrasonic energy transducer can be disposed to sense the wave energy traveling through the second specimen. The controller can be operatively coupled to the ultrasonic energy transducer. The controller can be configured to compare sensed wave energy to error compensation data and in response to said comparison adjust welding parameters in the dynamic welding environment.

Device (and system) embodiments of the present invention can also include additional features. For example, error compensation data can be based on a nuero-fuzzy error compensation model. Controllers can be further configured to compare the sensed wave energy to error compensation data to determine estimated time of flight data for use in estimating weld penetration depth. Controllers can also be further configured to determine an estimated weld penetration depth of the weld seam based on the error compensation model.

Other aspects and features of embodiments of the present invention will become apparent to those of ordinary skill in the art, upon reviewing the following description of specific, exemplary embodiments of the present invention in concert with the figures. While features of the present invention may be discussed relative to certain embodiments and figures, all embodiments of the present invention can include one or more of the features discussed herein. While one or more embodiments may be discussed as having certain advantageous features, one or more of such features may also be used with the various embodiments of the invention discussed herein. In similar fashion, while exemplary embodiments may be discussed below as system or method embodiments it is to be understood that such exemplary embodiments can be implemented in various devices, systems, and methods.

### BRIEF DESCRIPTION OF FIGURES

FIG. 1 schematically illustrates a time of flight path followed by an ultrasonic signal for ultrasonic penetration depth measurement.

FIG. 2 schematically illustrates an in-process weld penetration system in accordance with some embodiments of the present invention.

FIG. 3 graphically illustrates a sample weld wire feed rate used in testing embodiments of the present invention.

FIG. 4 graphically illustrates a sample recording of on-line ultrasonic signals during welding recorded in testing embodiments of the present invention.

FIG. 5 graphically illustrates a sample recording of off-line ultrasonic signals recorded during testing embodiments of the present invention.

FIG. 6 graphically illustrates a comparison of on-line and off-line time of flight measurements of a weld recorded during testing embodiments of the present invention.

FIG. 7 graphically illustrates a comparison of off-line and estimated time of flight data obtained during testing embodiments of the present invention.

FIG. 8 graphically illustrates a comparison of off-line time of flight, actual penetration depth, and estimated penetration depth data obtained during testing embodiments of the present invention.

FIG. 9 schematically illustrates a destructive testing embodiment in accordance with some embodiments of the present invention.

FIG. 10 graphically illustrates performance of the destructive measurement prediction model performance for (a) training and (b) checking data in accordance with some embodiments of the present invention.

FIG. 11 graphically illustrates penetration depths measured destructively, offline after welding and in-process using the destructive measurement prediction model. (FIGS. 11(a)-11(d) correspond to samples 1-4).

FIG. 12 graphically illustrates penetration depths measured destructively, offline after welding and in-process using the destructive measurement prediction model. (FIGS. 12(a)-12(d) correspond to samples 5-7).

FIG. 13 graphically illustrates penetration depths measured destructively, offline after welding and in-process using the destructive measurement prediction model. (FIGS. 13(a)-13(d) correspond to samples 8-9).

### DETAILED DESCRIPTION OF PREFERRED & ALTERNATIVE EMBODIMENTS

To facilitate an understanding of the principles and features of the various embodiments of the invention, various illustrative embodiments are explained below. As will be explained, embodiments of the present invention are generally directed to improved welding systems and methods capable of monitoring and correcting in-process welding due to ever-changing dynamic welding condition. According to some embodiments, an error compensation model is formulated and used to provide an estimated weld penetration depth relative to measured/sensed conditions. Currently preferred models are based on a neuro-fuzzy dynamic system. Testing has shown that embodiments of the present invention are effective in reducing effects of increased temperatures found during welding. As will be discussed, welding environments can negatively effect ultrasonic penetration depth measurement at various torch to sensor distances. Use of an error compensation model enables non-contact traditional ultrasonic techniques to be applied to online penetration depth sensing with reduced measurement error.

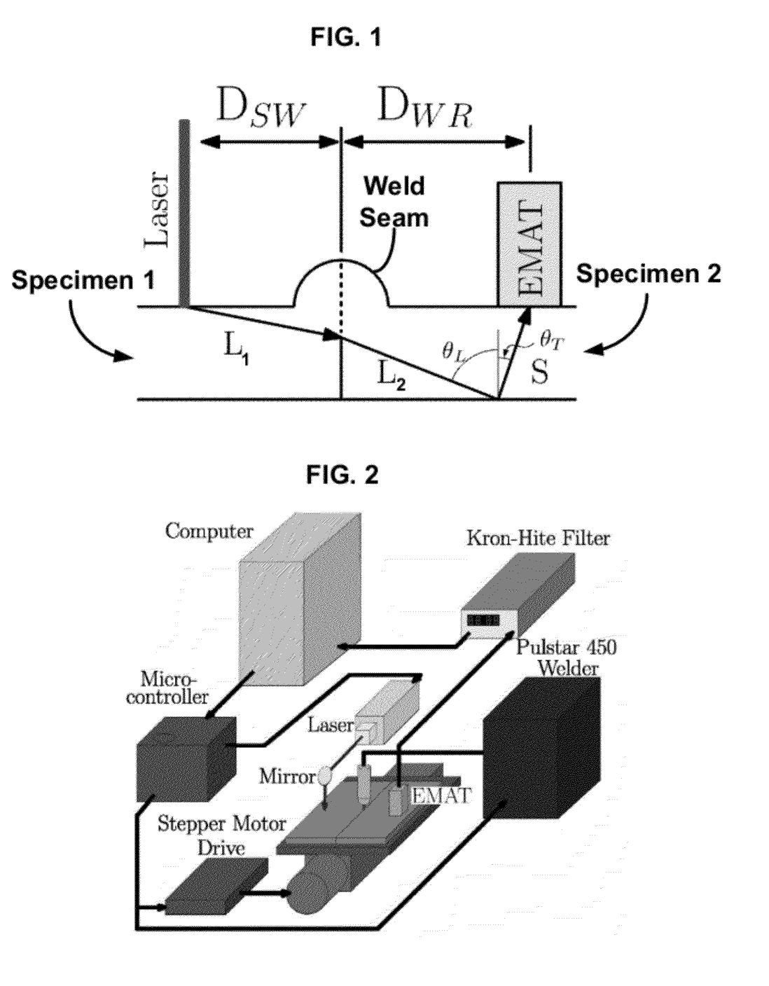

Turning now to the figures, FIG. 1 schematically illustrates a time of flight path followed by an ultrasonic signal for ultrasonic penetration depth measurement. Embodiments of the present invention can include hardware and software components to provide/generate weld depth penetration data in accordance with FIG. 1. As shown, a first specimen has or is being welded to a second specimen. A weld seam formed by welding joins the first specimen to the second specimen. Weld seam quality can be inspected by looking at weld penetration depth.

Weld penetration depth is generally measured by relating weld geometry to signal time of flight (ToF). The ToF is the time it takes for the wave to travel from an ultrasonic energy source (e.g., a laser) aimed at the first specimen to a receiver (e.g., an EMAT) located across the weld seam and proximate the second specimen. The path the ultrasound (or ultrasonic energy) follows is depicted in FIG. 1. Other paths may be used, but care must be taken to ensure an arriving wave will not be interfered by other waves.

A laser can generate a longitudinal wave L1 that propagates from the laser to a tip of a weld crack/seam (D_{SW}). When the wave L1 reaches the crack tip, the wave L1 is diffracted at the weld seam boundary. A diffracted wave L2 reaches the bottom of the second specimen where it undergoes mode conversion to a shear wave that is finally received by the EMAT. The total path is referred to as the LdLS (Longitudinal diffracted Longitudinal to Shear) path. The LdLS path is used because the shear wave propagates to the EMAT at an angle (θ_{T}) that is close to normal to the second specimen's surface (typically ˜30°). This results in a strong signal as opposed to if the wave L2 approaches the EMAT at a shallow angle. In addition, the ToF of the path is small enough to ensure other ray paths that reach the EMAT will not interfere with the LdLS wave and cause error in the ToF measurement.

The ToF of the wave is related to the penetration depth and sensor placements as shown in Eq. 1. D_{SW} is the distance from the source to the weld, T is the plate thickness, pd is the penetration depth, and C_{L} and C_{T} are the longitudinal and shear wave velocities, respectively (5965 and 3234 m/s for mild steel at room temperature).

$$ToF = \frac{\sqrt{{pd}^{2} + {D}_{SW}^{2}}}{{C}_{L}} + \frac{T - pd}{{C}_{L} cos {θ}_{L}} + \frac{T}{{C}_{T} cos {θ}_{T}} \qquad Eq . 1$$

The angles θ_{L} and θ_{T} are determined by iteratively solving Eqs. 2 & 3, where D_{WR} is the distance from the weld to receiver.

$$\begin{matrix}{D}_{WR} = ( T - pd ) tan {θ}_{L} + T tan {θ}_{T} & Eq . 2 \\ \frac{sin {θ}_{L}}{{C}_{L}} = \frac{sin {θ}_{T}}{{C}_{T}} & Eq . 3\end{matrix}$$

To measure the ToF of the LdLS wave in received signal data, a cross-correlation technique (discussed in more detail below) is used. This technique permits measurement of the ToF of ultrasonic waves even in the presence of noise.

FIG. 2 schematically illustrates an in-process weld penetration system 200 in accordance with some embodiments of the present invention. The system 200 is a currently preferred embodiment of the present invention and other system/device embodiments are possible to achieve the principles of the present invention. Indeed, the system 200 can be dispersed with various components in a manufacturing setting or integrated in a smaller setting. Some embodiments may have a single controller/processor module with many welding stations being monitored and controlled by the single controller/processor module. Some embodiments may have multiple controller/processor modules controlling multiple welding stations. Welding stations may be manual-type stations or, more preferably, automated-robotic-type welding stations. Control settings may be initialized with software logic and then used to monitor/control welding operations to achieve predetermined results (e.g., a preferred weld penetration depth).

Referring to the system 200, it is preferably an automated system that coordinates welding and inspection processes. In a traditional robotic welding system, the welding torch is attached to the end-effector of a multi degree of freedom robot. This enables positioning of the welding torch throughout complex welding paths. In some embodiments, the welding torch is held fixed and welding samples are moved. This permits consistent positioning of welding torch and data sensor. In other embodiments, the welding torch can be moved as desired and in some embodiments both the welding torch and welding samples can be moved. Movement of the welding torch and welding specimens can be manual and/or automated as desired or needed.

In testing embodiments of the invention, the inventors have developed the following currently preferred welding system set-up parameters. Various other welding system configurations can be utilized as desired or needed. Sample specimens to be welded together can be placed on a fixture attached to a carriage of a linear positioning axis driven by a five-phase stepper motor. The welding torch can be connected to a Miller Pulstar 450 gas metal arc welder with a robot interface that allows electronic command of welding parameters and process. A laser beam (e.g., generated by an Nd:YAG laser) can be directed to a surface of a first specimen on one side (e.g., the left side) of a weld seam. The laser can output 220 mJ per pulse at a rate of 20 Hz. The laser beam can pass through a variable output beam splitter and can be directed to the surface of the sample by a mirror. The beam splitter can be adjusted to pass roughly 99% of the beam energy through the primary output and 1% to a photodiode. The signal from the photodiode is used to trigger acquisitions of the ultrasonic signals.

After the ultrasound generated by the laser passes through the weld, it is received by a sensor transducer (e.g., an EMAT) located on the right side of the weld seam. The EMAT has a coil with dimensions 4.1×13.7 mm and integral pre-amp with bandwidth approximately 0.5 to 2.0 MHz. The EMAT and laser incident locations lie on a line normal to the weld seam a fixed distance behind the torch. To eliminate low frequency noise and prevent aliasing, the output of the EMAT is filtered by a Kron-Hite filter configured as a band-pass filter with passband 100 kHz to 5 MHz. A 12-bit data acquisition card sampling at 125 MHz digitizes the filtered signals.

As mentioned above, system 200 can be automated. Automation can be enabled via use of controller (e.g., a microcontroller or processor). In some embodiments, and as illustrated, the stage, welder, and laser are coupled to and controlled by a microcontroller. The microcontroller can ensure that the laser is fired at correct time intervals and the velocity of the samples under the torch is correct. The microcontroller can also specify arc voltage levels and wire feed rate during the weld as programmed. The controller is preferably pre-programmed with welding job parameters and welding monitoring correction controls as discussed below. This enables the controller to receive data inputs and in response modify welding system parameters to ensure that deviations in welding system parameters are maintained. This also enables in-process welding to be controlled according to system parameters thereby reducing error.

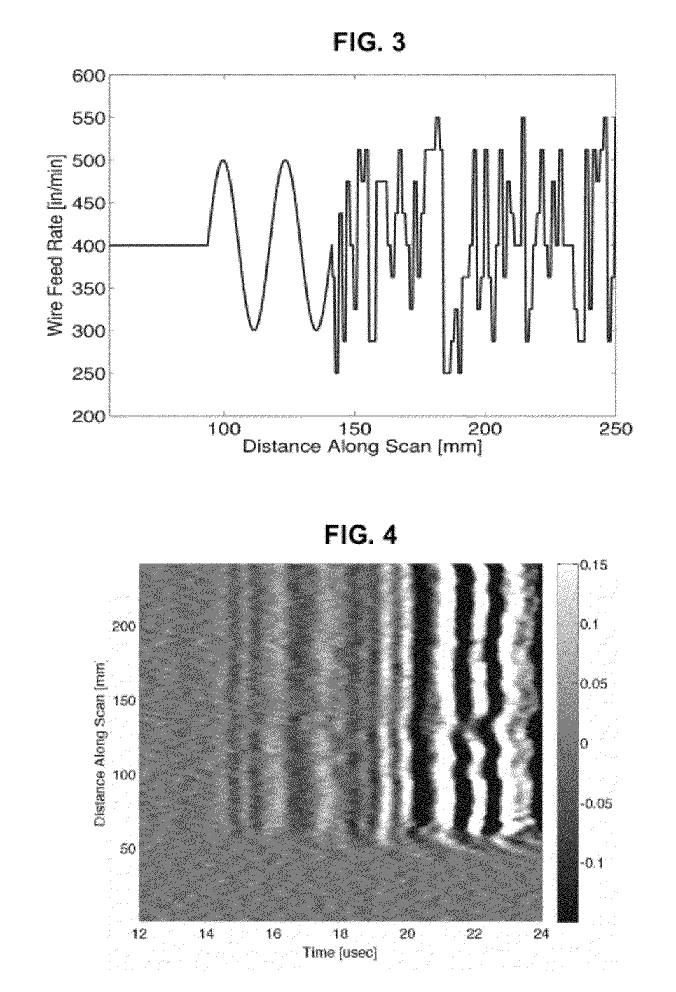

To reduce error in an online weld penetration depth measurement, a neuro-fuzzy model can be used in accordance with embodiments of the present invention. This model relates welding parameters and measured ToF to a ToF obtained offline. To determine model parameters, an input is designed to excite a welding system (such as system 200) over the operating range of the model. The system is programmed to weld a 200 mm long bead to join two 101×305×12.6 mm thick 1018 steel plates in a butt weld configuration. The arc voltage is held fixed at 25 V and the samples move at a velocity of 0.375 in/s (9.5 mm/s). The laser is fired at a rate of 20 Hz, resulting in 0.476 mm between measurement locations. The distance from the laser source to the weld seam D_{SW} is 27.8 mm. The EMAT is placed at a distance of 35.3 mm from the weld on the other side. The Wire Feed Rate (WFR) is programmed to follow constant 400 in/min followed by a 2 period sinusoid and a multi-level pseudo random sequence. The sequence is shown in FIG. 3. The laser incident location and EMAT are 56 mm behind the torch. Thus, the system begins to measure the weld after 56 mm of travel along the welding path.

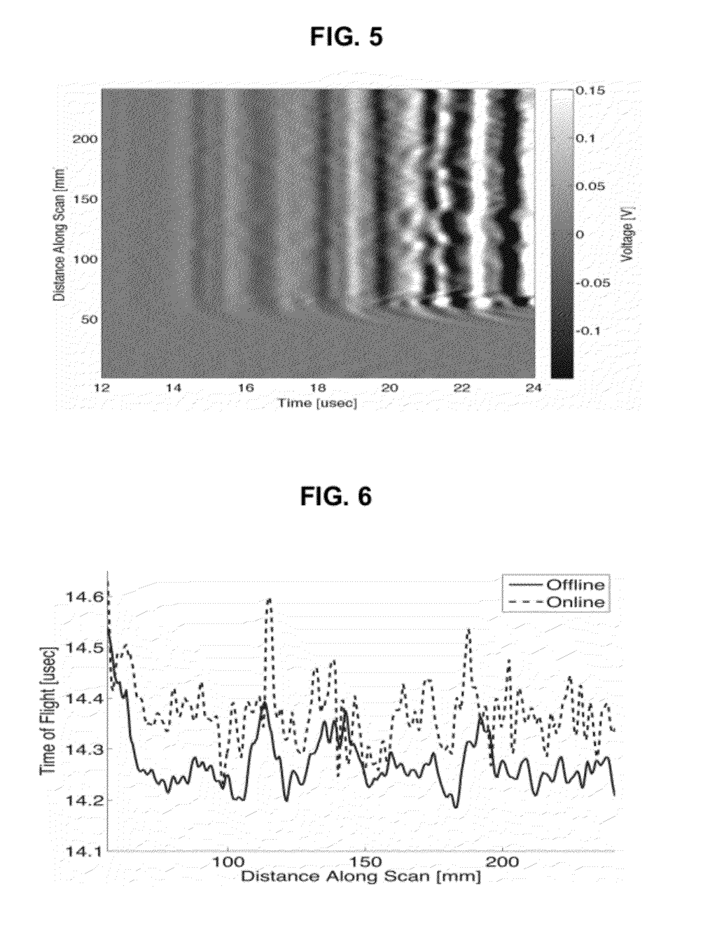

While welding occurs, ultrasonic data is recorded each time the laser is fired. After welding, the sample is allowed to cool to room temperature. The system then scans the sample at the same locations as were measured during welding. At each location, the laser is fired 20 times and the signals averaged to increase the signal to noise ratio. To reduce the influence of noise on the ToF measurement, the signals are filtered in software by a band pass FIR equiripple filter. Since the filter is linear phase, the group delay of the filter is constant and is compensated in software and does not affect the ToF measurement. The filter is created using the MATLAB fdatool filter design tool with the following parameters: Fstop1=0.4 MHz, Fpass1=0.6, Fpass2=2.0 MHz, and Fstop2=2.3 MHz. The pass and stop frequencies were determined by matching the frequency characteristics of the received ultrasound. In this way, the amplitude of the received ultrasound is minimally affected and the noise is reduced. The filtered online and offline data are presented in FIGS. 4 and 5, respectively. In the figures, the abscissa represents time, the ordinate the distance from the start of the scan, and color indicates signal voltage as shown in the color bar.

As can be seen by comparing FIGS. 4 and 5, signals recorded on-line during welding have significantly larger noise amplitude and arrive later than those recorded off-line at room temperature. This is due to the decrease in wave velocity as temperature increases. Changes in wave speed affect the relationship between measured ToF and penetration depth, introducing an error in the measured penetration depth if the relationship in Eq. 1 is used. As described above, weld penetration depth is determined by relating the measured time of flight to the path the ultrasound follows. The LdLS wave arrives at approximately 14.25 usec. Even though the amplitude of the wave is less than the subsequent waves received by the EMAT, this wave is used since it is not interfered by other waves.

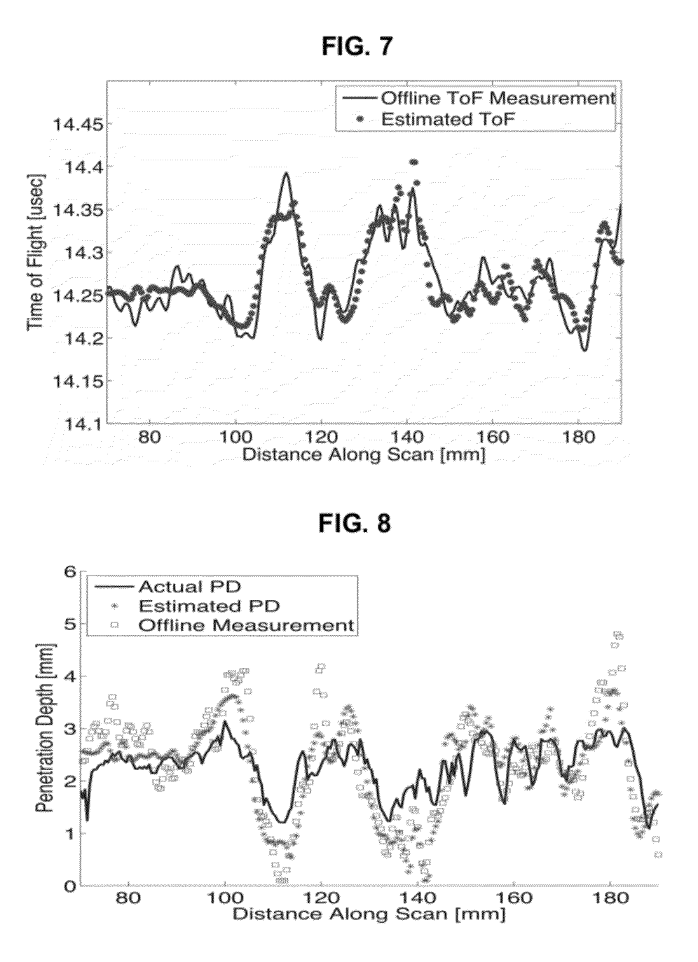

The ToF of the LdLS wave is determined by means of cross-correlation. A reference signal with a known ToF is cross-correlated with the received signal. By determining the peak of the cross-correlation, the difference in ToF between the reference and the received signal is calculated. A comparison of ToF of the waves received online and offline are shown in FIG. 6. The penetration depth corresponding to the ToF measured offline is shown in FIG. 7. More oscillation is present in the online data, due to the increased noise amplitude. The trend, however, in the signals is similar. This suggests that the online measurement can be used to estimate the penetration depth.

To compensate for error introduced by elevated temperature field present during welding, the inventors presently prefer a neuro-fuzzy error compensation model. The model produces an estimate of the ToF error based on online ToF measurement and time history of the wire feed rate (WFR). The estimated error is then compared to or subtracted from the online ToF measurement to yield an estimated ToF. Eq. 1 can then be used to calculate an estimate of the penetration depth. A goal of the error compensation model is to produce an online measurement that performs as well as the offline ultrasonic penetration depth measurement.

To capture effects of welding parameters on the error, the WFR is included as input to the model. Since the WFR at a particular point in the welding path contributes to the temperature at locations both before and after the torch, however, the wire feed rate is preprocessed by filtering it with a moving average filter with length 21. Thus, the model takes in the average of the wire feed rate at a particular location and 10 neighbors to either side (a total length of 9.5 mm). This length of filter was used because the torch deposits material on the weld bead over a distance approximately equal to 10 mm. In this way, the model can capture the distributed nature of the torch heat input.

To train the model, the ANFIS routines included in the MATLAB Fuzzy Logic Toolbox are used. ToF error between the offline and online ToF measurements is calculated. The model is trained using the same physical specimen. While the specimen is welded, ultrasound is generated and the time of flight is measured. The specimen is allowed to cool and again ultrasound is generated and ToF is measured. This is the model output target. The online ToF measurement is included as an input to the model. The other input(s) are selected from six possible choices. The model produces an output based on up to 4 inputs (this is a limitation of the MATLAB implementation of the ANFIS model). The performance of the model will be partly based on which of the 6 inputs listed are selected. The averaged wire feed rate for locations 0.0, 2.4, 4.8, 7.14, 9.5 and 11.9 mm from the current measurement location are all possible inputs. To determine the most appropriate input(s), a search is performed in which the model is trained for all combination of inputs so that the online ToF measurement is included as the first input.

The total number of inputs can be varied from 1 to 4 (and other ranges as well). Two generalized bell membership functions are used per input and two trapezoidal membership functions are associated with the output. The selection of membership function type is an option left to the designer. These specific functions were selected for best performance in this implementation, but by no means are required. Other types of membership functions are possible.

To ensure the model is not over fit to the data, the performance of the model to predict the error in ToF for an additional sample is calculated for each training iteration. Training is performed using the “training dataset.” After each training iteration, the error between the model output and the output target is calculated and called the “training error.” The ANFIS algorithms use this training error to modify the model to reduce the error. In addition, another dataset called the “checking dataset” is input to the model and the “checking error” is calculated. This dataset is obtained under identical welding conditions (wire feed rate, voltage, etc.) and sensor placement. If the model is over fit, the training error will be low but the checking error will be high. The number of iterations varies but training stops when the RMSE of the checking error increases from one iteration to the next by an amount over a threshold.

This provides a means to validate the model and ensure the model is a representation of the physical process that causes the ToF error. When the Root Mean Square Error (RMSE) of the checking data begins to increase, the training halts to avoid over fitting. The best performing model structure contains three inputs: the online ToF measurement, the preprocessed wire feed rate at the measurement location, and the preprocessed wire feed rate at 11.9 mm earlier in the weld.

The estimated ToF for the checking sample along with the offline ToF measurement is given in FIG. 7. There is very good agreement, showing that the model is able to estimate the ToF measurement error for both the training and checking data. The estimated ToF is used to estimate the penetration depth. The actual penetration depth is measured by cutting the sample lengthwise next to the weld and machining down to the center plane of the joint. The penetration depth is then measured by capturing an image of the weld bead using a flatbed scanner with a resolution of 600 dpi. The penetration depth is calculated via image processing software. The optically measured actual penetration depth, offline ultrasonic penetration depth measurement and online estimated penetration depth are presented in FIG. 8. The RMSE for the offline measurement and online estimate are 0.74 and 0.72 mm, respectively.

It is clear that the model is able to estimate and greatly reduce the temperature-induced error present in online measurements. Error in the offline measurement can be partially attributed to the interference of waves that reach the EMAT after reflecting off the weld face locations neighboring the measurement location. When the penetration depth is not constant, there is a possible path for the ultrasound to reach the EMAT with a longer ToF. This is why the penetration depth measurement is more prone to error when there is a local minimum in penetration depth. For example, at 112 mm, the offline penetration depth measurement is much lower than the actual penetration depth. This is caused by ultrasound that diffracts off neighboring points at either side of the measurement location. The interference of these waves results in a longer ToF measurement and a reduced penetration depth measurement. Similar effects occur for local maxima such as seen at 100 and 180 mm along the scan path.

The model structure determined above is used to train error compensation models for two other torch to sensor distances (45 mm and 32 mm) behind the torch. Due to the physical size of the EMAT and beam steering mirror, smaller torch to sensor distances are not possible with the equipment used in this work. Resulting penetration depth RMSE for the four samples are shown below in Table I. For all distances, the model is able to approximate the performance of the offline measurement.

TABLE I
Penetration Depth Measurement RMSE

| Sample | D_{TS} | Offline RMSE | Model MSE |
|---|---|---|---|
| 1 | 56 mm | 0.69 mm | 0.67 mm |
| 2 | 56 mm | 0.74 mm | 0.72 mm |
| 3 | 45 mm | 0.56 mm | 0.66 mm |
| 4 | 32 mm | 0.40 mm | 0.53 mm |

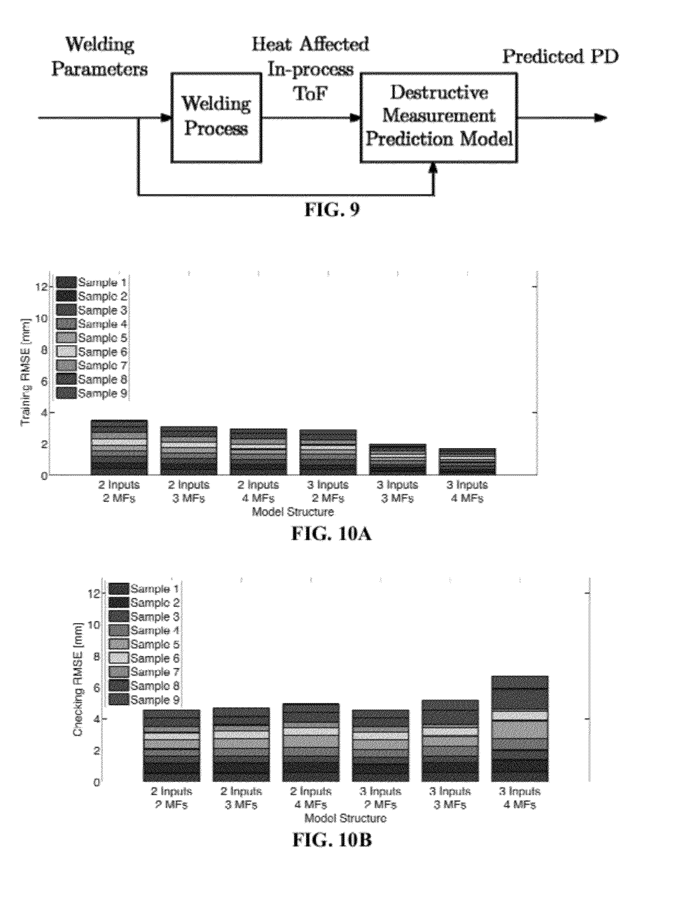

The above embodiments can be used when destructive testing data is not obtainable and obtaining the data is not preferred. Embodiments of the invention, however, are not limited to such situations. Indeed, if destructive penetration depth measurements are available, the model discussed above can be trained to output penetration depth directly from the in-process time of flight and the welding input parameters. This may be possible when inspection is performed in an assembly line setting where parts are pulled from the line for destructive off-line inspection.

Where destructive penetration depth measurements are available, the model training procedure is similar to that discussed above, but with a different target output. Rather than the difference of in-process and offline times of flight, the system is trained to produce the penetration depth obtained via destructive measurements (as graphically depicted in FIG. 9). We generally refer to this model as the destructive model below. In this way, the destructive model may be able to produce a more accurate measurement than the ToF error compensation model.

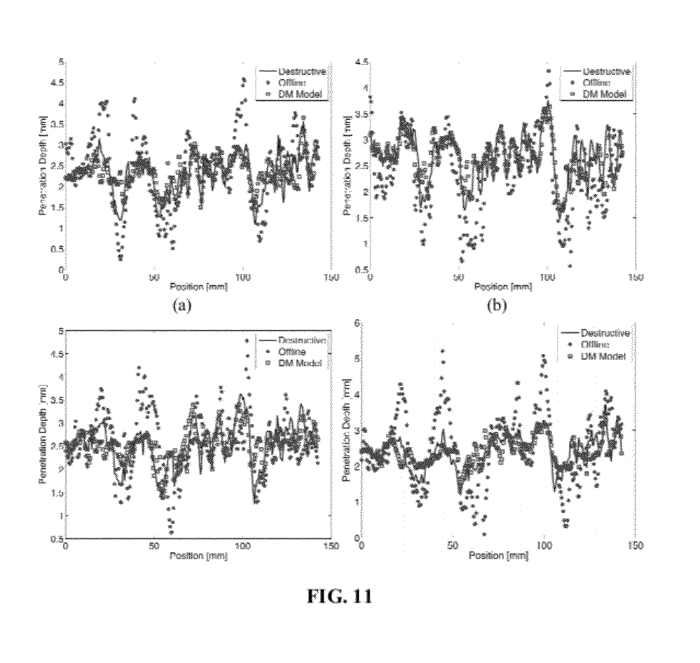

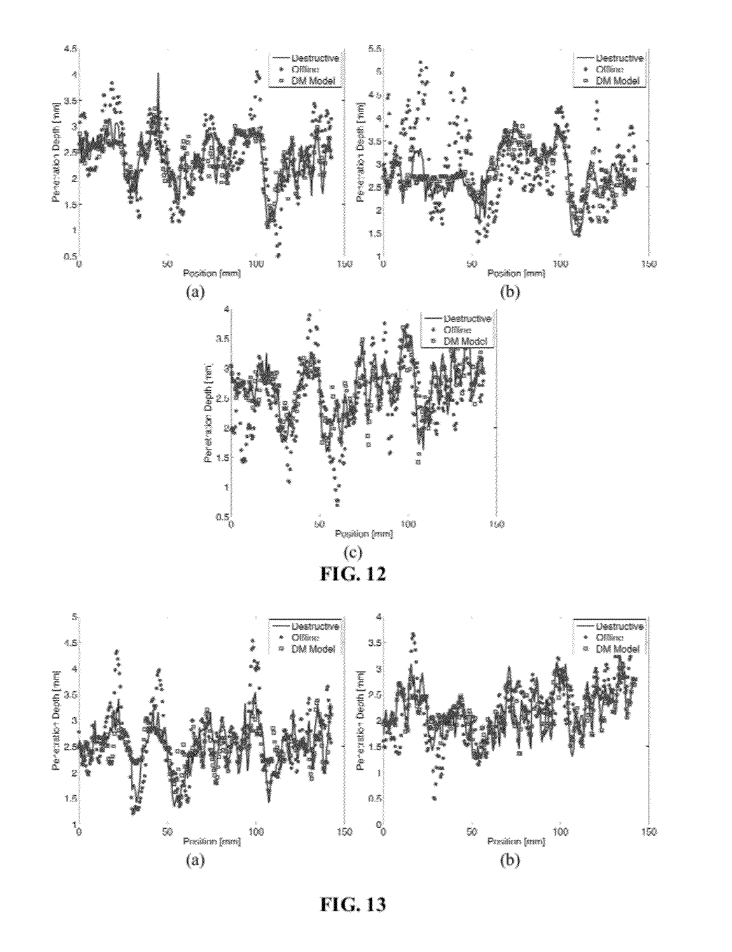

The destructive model can be trained with two and three inputs and with the number of membership functions ranging from two through four as in the previous scenario. The training and checking RMSE are shown in FIG. 10 for the six structures. Similar to the ToF error compensation model, the structures with larger numbers of free parameters tend to have larger checking error. For the destructive model, the structure with three inputs and three membership functions per input produces the lowest sum of training and checking error. The penetration depths measured destructively, offline using the LdLS technique, and using the destructive measurement prediction model are shown in FIGS. 11-13. The destructive measurement prediction model output tracks the destructively measured penetration depth very well. When compared to the penetration depth measured offline using the LdLS ToF technique, it is clear that the model has a much lower error.

The RMSE and mean, minimum, and maximum absolute percent errors for all measurement locations per sample were calculated. The results are shown below in Table II. The RMSE is improved over the ToF error compensation model. The RMSE for the nine samples is comparable across the nine samples ranging from 0.20 to 0.34 mm and shows consistent performance independent of the distance from the torch to the sensor. The mean absolute percent error is good, with a maximum of 12.2% and a minimum of 5.9%. The minimum absolute percent error is very good, with a maximum of 0.05%. The maximum percent error is quite large for some samples. For Sample 1, the maximum percent error is 95.0%. This corresponds to location 31 mm where the actual penetration depth is 1.21 mm and the model penetration depth is 2.35 mm. This combination of a large error and small actual penetration depth results in a large percent error.

TABLE II
RMSE and mean absolute percent error for destructive measurement
prediction model output

| | | | | Min | Max |
|---|---|---|---|---|---|
| | | | Mean | Absolute | Absolute |
| | | DM Model | Absolute % | % | % |
| Sample | D_{TS} [mm] | RMSE [mm] | Error | Error | Error |
| 1 | 56 | 0.34 | 12.2 | 0.03 | 95.0 |
| 2 | 56 | 0.25 | 7.3 | 0.04 | 40.2 |
| 3 | 51 | 0.32 | 10.2 | 0.01 | 77.3 |
| 4 | 51 | 0.31 | 10.9 | 0.01 | 69.9 |
| 5 | 45 | 0.22 | 6.7 | 0.03 | 46.9 |
| 6 | 45 | 0.28 | 8.2 | 0.00 | 52.0 |
| 7 | 38 | 0.20 | 5.9 | 0.03 | 34.0 |
| 8 | 32 | 0.31 | 10.5 | 0.05 | 64.4 |
| 9 | 32 | 0.23 | 9.0 | 0.03 | 44.6 |

In order to show the performance of the offline LdLS technique, the ToF error compensation model and destructive measurement prediction model, the measurements, errors, and absolute percent errors were calculated for five locations in each sample (and tabulated below). The locations are 0, 34, 71, 107, and 142 mm. Typically, the ToF error compensation model performs comparably to the offline LdLS technique. The destructive measurement prediction model performs better overall. The mean absolute percent errors for all measurement locations for the offline LdLS, ToF error compensation model, and destructive measurement prediction model are 23.5, 18.0, and 9.0%, respectively. However, there is variation among the measurement locations. These results indicate that the two models both accomplish their goals. When destructive measurements are not available, the ToF error compensation technique can produce an estimate of the offline weld penetration depth measurement. When destructive measurements are available, the destructive measurement prediction model can be used to yield results with significantly improved performance.

TABLE III
Penetration depth measurements obtained destructively, offline via
LdLS technique, using ToF error compensation model (ToF Model)
and destructive measurement prediction model (DM Model)
for Sample 1

| Location | 0 mm | 34 mm | 71 mm | 107 mm | 142 mm |
|---|---|---|---|---|---|
| Destructive PD | 2.18 | 2.59 | 2.78 | 1.13 | 2.63 |
| Measurement [mm] | | | | | |
| Offline PD Measurement | 3.02 | 2.10 | 2.88 | 1.58 | 2.95 |
| [mm] | | | | | |
| Offline PD Error [mm] | 0.84 | −0.49 | 0.10 | 0.45 | 0.32 |
| Offline Absolute % Error | 38.5 | 18.9 | 3.6 | 39.8 | 12.2 |
| ToF Model PD | 2.85 | 2.28 | 3.15 | 1.53 | 2.16 |
| Measurement [mm] | | | | | |
| ToF Model PD Error [mm] | 0.67 | −0.31 | 0.37 | 0.40 | −0.47 |
| ToF Model Absolute % | 30.7 | 12.0 | 13.3 | 35.4 | 17.9 |
| Error | | | | | |
| DM Model PD | 2.20 | 2.15 | 2.71 | 1.44 | 2.69 |
| Measurement [mm] | | | | | |
| DM Model PD Error [mm] | 0.02 | −0.44 | −0.07 | 0.31 | 0.06 |
| DM Model Absolute % | 0.9 | 17.0 | 2.5 | 27.4 | 2.3 |
| Error | | | | | |

TABLE IV
Penetration depth measurements obtained destructively, offline via
LdLS technique, using ToF error compensation model (ToF Model)
and destructive measurement prediction model (DM Model)
for Sample 2

| Location | 0 mm | 34 mm | 71 mm | 107 mm | 142 mm |
|---|---|---|---|---|---|
| Destructive PD | 3.15 | 2.66 | 2.83 | 1.56 | 2.70 |
| Measurement [mm] | | | | | |
| Offline PD Measurement | 3.82 | 2.55 | 2.47 | 1.20 | 2.68 |
| [mm] | | | | | |
| Offline PD Error [mm] | 0.67 | −0.11 | −0.36 | −0.36 | −0.02 |
| Offline Absolute % Error | 21.3 | 4.1 | 12.7 | 23.1 | 0.7 |
| ToF Model PD | 3.59 | 2.98 | 2.55 | 1.31 | 2.67 |
| Measurement [mm] | | | | | |
| ToF Model PD Error [mm] | 0.44 | 0.32 | −0.28 | −0.25 | −0.03 |
| ToF Model Absolute % | 14.0 | 12.0 | 9.9 | 16.0 | 1.1 |
| Error | | | | | |
| DM Model PD | 3.08 | 3.13 | 2.79 | 1.72 | 2.75 |
| Measurement [mm] | | | | | |
| DM Model PD Error [mm] | −0.07 | 0.47 | −0.04 | 0.16 | 0.05 |
| DM Model Absolute % | 2.2 | 17.7 | 1.4 | 10.3 | 1.9 |
| Error | | | | | |

TABLE V
Penetration depth measurements obtained destructively, offline via
LdLS technique, using ToF error compensation model (ToF Model)
and destructive measurement prediction model (DM Model)
for Sample 3

| Location | 0 mm | 34 mm | 71 mm | 107 mm | 142 mm |
|---|---|---|---|---|---|
| Destructive PD | 2.53 | 2.89 | 2.67 | 1.06 | 2.38 |
| Measurement [mm] | | | | | |
| Offline PD Measurement | 2.66 | 2.16 | 3.02 | 1.85 | 2.38 |
| [mm] | | | | | |
| Offline PD Error [mm] | 0.13 | −0.73 | 0.35 | 0.79 | 0.77 |
| Offline Absolute % Error | 5.1 | 25.3 | 13.1 | 74.5 | 32.4 |
| ToF Model PD | 2.99 | 2.77 | 2.66 | 1.76 | 2.68 |
| Measurement [mm] | | | | | |
| ToF Model PD Error [mm] | 0.46 | −0.12 | −0.01 | 0.70 | 0.30 |
| ToF Model Absolute % | 18.2 | 4.2 | 0.4 | 66.0 | 12.6 |
| Error | | | | | |
| DM Model PD | 2.52 | 2.62 | 2.66 | 1.07 | 2.40 |
| Measurement [mm] | | | | | |
| DM Model PD Error [mm] | −0.01 | −0.25 | −0.01 | 0.01 | 0.02 |
| DM Model Absolute % | 0.4 | 8.7 | 0.4 | 0.9 | 0.8 |
| Error | | | | | |

TABLE VI
Penetration depth measurements obtained destructively, offline via
LdLS technique, using ToF error compensation model (ToF Model)
and destructive measurement prediction model (DM Model)
for Sample 4

| Location | 0 mm | 34 mm | 71 mm | 107 mm | 142 mm |
|---|---|---|---|---|---|
| Destructive PD | 3.03 | 2.36 | 3.54 | 1.55 | 2.65 |
| Measurement [mm] | | | | | |
| Offline PD Measurement | 2.98 | 3.13 | 2.95 | 2.29 | 3.08 |
| [mm] | | | | | |
| Offline PD Error [mm] | −0.05 | 0.77 | −0.59 | 0.74 | 0.43 |
| Offline Absolute % Error | 1.7 | 32.6 | 16.7 | 47.7 | 16.2 |
| ToF Model PD | 3.02 | 3.14 | 3.39 | 2.97 | 2.89 |
| Measurement [mm] | | | | | |
| ToF Model PD Error [mm] | −0.01 | 0.78 | −0.15 | 1.42 | 0.24 |
| ToF Model Absolute % | 0.33 | 33.1 | 4.2 | 91.6 | 9.1 |
| Error | | | | | |
| DM Model PD | 2.70 | 2.74 | 3.31 | 2.36 | 3.09 |
| Measurement [mm] | | | | | |
| DM Model PD Error [mm] | −0.33 | 0.38 | −0.23 | 0.81 | 0.44 |
| DM Model Absolute % | 10.9 | 16.1 | 6.5 | 52.3 | 16.6 |
| Error | | | | | |

TABLE VII
Penetration depth measurements obtained destructively, offline via
LdLS technique, using ToF error compensation model (ToF Model)
and destructive measurement prediction model (DM Model)
for Sample 5

| Location | 0 mm | 34 mm | 71 mm | 107 mm | 142 mm |
|---|---|---|---|---|---|
| Destructive PD | 2.45 | 2.23 | 2.51 | 1.68 | 3.08 |
| Measurement [mm] | | | | | |
| Offline PD Measurement | 2.78 | 1.63 | 2.73 | 1.67 | 2.57 |
| [mm] | | | | | |
| Offline PD Error [mm] | 0.30 | −0.60 | 0.22 | −0.01 | −0.51 |
| Offline Absolute % Error | 12.1 | 26.9 | 8.8 | 0.6 | 16.6 |
| ToF Model PD | 2.35 | 2.05 | 3.06 | 2.22 | 2.79 |
| Measurement [mm] | | | | | |
| ToF Model PD Error [mm] | −0.13 | −0.18 | 0.55 | 0.54 | −0.29 |
| ToF Model Absolute % | 5.2 | 8.1 | 21.9 | 32.1 | 9.4 |
| Error | | | | | |
| DM Model PD | 2.50 | 2.24 | 2.60 | 2.14 | 3.11 |
| Measurement [mm] | | | | | |
| DM Model PD Error [mm] | 0.02 | 0.01 | 0.09 | 0.46 | 0.03 |
| DM Model Absolute % | 0.8 | 0.5 | 3.6 | 27.4 | 1.0 |
| Error | | | | | |

TABLE VIII
Penetration depth measurements obtained destructively, offline via
LdLS technique, using ToF error compensation model (ToF Model)
and destructive measurement prediction model (DM Model)
for Sample 6

| Location | 0 mm | 34 mm | 71 mm | 107 mm | 142 mm |
|---|---|---|---|---|---|
| Destructive PD | 1.72 | 1.89 | 3.03 | 1.31 | 2.78 |
| Measurement [mm] | | | | | |
| Offline PD Measurement | 1.60 | 1.66 | 2.25 | 2.48 | 3.84 |
| [mm] | | | | | |
| Offline PD Error [mm] | −0.12 | −0.23 | −0.78 | 1.17 | 1.06 |
| Offline Absolute % Error | 7.0 | 12.2 | 25.7 | 89.3 | 38.1 |
| ToF Model PD | 1.63 | 2.03 | 2.27 | 1.81 | 2.26 |
| Measurement [mm] | | | | | |
| ToF Model PD Error [mm] | −0.09 | 0.14 | −0.76 | 0.50 | −0.52 |
| ToF Model Absolute % | 5.2 | 7.4 | 25.1 | 38.2 | 18.7 |
| Error | | | | | |
| DM Model PD | 1.94 | 2.02 | 2.80 | 1.64 | 2.79 |
| Measurement [mm] | | | | | |
| DM Model PD Error [mm] | 0.22 | 0.13 | −0.23 | 0.33 | 0.01 |
| DM Model Absolute % | 12.8 | 6.9 | 7.6 | 25.2 | 0.4 |
| Error | | | | | |

TABLE IX
Penetration depth measurements obtained destructively, offline via
LdLS technique, using ToF error compensation model (ToF Model)
and destructive measurement prediction model (DM Model)
for Sample 7

| Location | 0 mm | 34 mm | 71 mm | 107 mm | 142 mm |
|---|---|---|---|---|---|
| Destructive PD | 3.08 | 2.31 | 2.91 | 1.81 | 2.91 |
| Measurement [mm] | | | | | |
| Offline PD Measurement | 1.97 | 1.99 | 2.41 | 2.53 | 2.78 |
| [mm] | | | | | |
| Offline PD Error [mm] | −1.11 | −0.32 | −0.50 | 0.73 | −0.13 |
| Offline Absolute % Error | 36.0 | 13.9 | 17.2 | 39.8 | 4.5 |
| ToF Model PD | 1.89 | 2.28 | 2.91 | 2.32 | 2.28 |
| Measurement [mm] | | | | | |
| ToF Model PD Error [mm] | −1.19 | −0.03 | 0.00 | 0.51 | −0.63 |
| ToF Model Absolute % | 38.6 | 1.3 | 0.0 | 28.2 | 21.7 |
| Error | | | | | |
| DM Model PD | 3.03 | 2.31 | 3.08 | 1.96 | 2.92 |
| Measurement [mm] | | | | | |
| DM Model PD Error [mm] | −0.05 | 0.00 | 0.17 | 0.15 | 0.01 |
| DM Model Absolute % | 1.6 | 0.0 | 5.8 | 8.3 | 0.3 |
| Error | | | | | |

TABLE X
Penetration depth measurements obtained destructively, offline via
LdLS technique, using ToF error compensation model (ToF Model)
and destructive measurement prediction model (DM Model)
for Sample 8

| Location | 0 mm | 34 mm | 71 mm | 107 mm | 142 mm |
|---|---|---|---|---|---|
| Destructive PD | 2.65 | 2.31 | 2.95 | 1.25 | 2.44 |
| Measurement [mm] | | | | | |
| Offline PD Measurement | 2.40 | 1.37 | 2.62 | 1.95 | 2.14 |
| [mm] | | | | | |
| Offline PD Error [mm] | −0.25 | −0.94 | −0.33 | 0.70 | −0.30 |
| Offline Absolute % Error | 9.4 | 40.7 | 11.2 | 56.0 | 12.3 |
| ToF Model PD | 2.34 | 2.38 | 2.69 | 2.47 | 2.73 |
| Measurement [mm] | | | | | |
| ToF Model PD Error [mm] | −0.31 | 0.07 | −0.26 | 1.22 | 0.29 |
| ToF Model Absolute % | 11.7 | 3.0 | 8.8 | 97.6 | 11.9 |
| Error | | | | | |
| DM Model PD | 2.57 | 2.51 | 3.18 | 0.97 | 0.21 |
| Measurement [mm] | | | | | |
| DM Model PD Error [mm] | −0.08 | 0.20 | 0.23 | 0.97 | 0.21 |
| DM Model Absolute % | 3.0 | 8.7 | 7.8 | 77.6 | 8.6 |
| Error | | | | | |

TABLE XI
Penetration depth measurements obtained destructively, offline via
LdLS technique, using ToF error compensation model (ToF Model)
and destructive measurement prediction model (DM Model)
for Sample 9

| Location | 0 mm | 34 mm | 71 mm | 107 mm | 142 mm |
|---|---|---|---|---|---|
| Destructive PD | 2.48 | 2.10 | 2.74 | 1.59 | 2.36 |
| Measurement [mm] | | | | | |
| Offline PD Measurement | 2.16 | 1.14 | 3.11 | 2.10 | 3.17 |
| [mm] | | | | | |
| Offline PD Error [mm] | −0.32 | −0.96 | 0.37 | 0.51 | 0.81 |
| Offline Absolute % Error | 12.9 | 45.7 | 13.5 | 32.1 | 34.3 |
| ToF Model PD | 2.01 | 2.44 | 2.26 | 2.06 | 2.99 |
| Measurement [mm] | | | | | |
| ToF Model PD Error [mm] | −0.47 | 0.34 | −0.48 | 0.47 | 0.63 |
| ToF Model Absolute % | 19.0 | 16.2 | 17.5 | 29.6 | 26.7 |
| Error | | | | | |
| DM Model PD | 2.41 | 2.12 | 2.65 | 2.01 | 2.35 |
| Measurement [mm] | | | | | |
| DM Model PD Error [mm] | −0.07 | 0.02 | −0.09 | 0.42 | −0.01 |
| DM Model Absolute % | 2.8 | 1.0 | 3.3 | 26.4 | 0.4 |
| Error | | | | | |

The embodiments of the present invention are not limited to the particular formulations, process steps, and materials disclosed herein as such formulations, process steps, and materials may vary somewhat. The terminology employed herein is used for the purpose of describing exemplary embodiments only and the terminology is not intended to be limiting since the scope of the various embodiments of the present invention will be limited only by the appended claims and equivalents thereof. The descriptions are exemplary and yet other features and embodiments exist.

While embodiments of the invention are described with reference to embodiments, those skilled in the art will understand that variations and modifications can be effected within the scope of the appended claims. The scope of the various embodiments of the present invention should not be limited to the above discussed embodiments. The full scope of the invention and all equivalents should only be defined by the following claims and all equivalents.

We claim:

1. An in-process welding device to compensate for error associated with detected weld penetration depth, the device comprising:
an ultrasonic energy source disposed to generate ultrasonic energy through a first specimen being welded to a second specimen, wherein a weld seam is used to join the first specimen to the second specimen;
an ultrasonic sensor disposed on an opposite side of the weld seam from the ultrasonic energy source, the ultrasonic sensor configured to detect ultrasonic energy propagated from the first specimen side of the weld seam to the second specimen side of the weld seam; and
a controller disposed to receive data from the ultrasonic sensor and configured to determine time of flight signal data corresponding to arrival of the ultrasonic energy detected by the ultrasonic sensor and further configured to compare the determined time of flight signal data to a model to compute error associated with the determined time of flight signal data due to a dynamic welding environment.

2. The in-process welding device of claim 1, wherein the controller is configured to utilize the computed error to adjust welding parameters in the dynamic welding environment based on the computed error.

3. The in-process welding device of claim 1, wherein the controller is configured to utilize the computed error to determine an estimated time of flight value for use in estimating weld penetration depth.

4. The in-process welding device of claim 1, wherein the model is based on a neuro-fuzzy based dynamic data model based at least partially on wire feed rate history.

5. The in-process welding device of claim 1, wherein the controller is configured to vary at least one of location of the first and second specimens, laser parameters, and weld parameters in the dynamic welding environment based on the computed error.

6. The in-process welding device of claim 1, wherein the ultrasonic energy source comprises at least one of a pulsed laser, laser, laser phase array, and an EMAT.

7. The in-process welding device of claim 1, wherein the ultrasonic sensor comprises at least one of an electro-magnetic acoustic transducer, a piezo-electric transducer, laser inferometer, and vibrometer.

8. The in-process welding device of claim 1, wherein the controller receives ultrasonic energy from the ultrasonic energy source for use in instructing the ultrasonic sensor to detect ultrasonic energy propagated through the first specimen.

9. The in-process welding device of claim 1, wherein the model is trained at least partially based on test samples that have been characterized via destructive testing.

10. An in-process welding method to compensate for error occurring during welding processes, the method comprising:
preparing an error compensation model to account for error introduced during a dynamic welding environment;
sensing on-line time of flight data proximate one or more welding specimens during a dynamic welding environment with one or more data sensors; and
providing estimated time of flight data based on the error compensation model and the sensed on-line time of flight data.

11. The method of claim 10, further comprising subtracting estimated time of flight error based on the error compensation model from the sensed on-line time of flight data to provide the estimated time of flight data.

12. The method of claim 10, wherein the error compensation model is a neuro-fuzzy compensation model.

13. The method of claim 10, further comprising altering welding system parameters in response to the estimated time of flight data.

14. The method of claim 10, further comprising providing an ultrasonic energy source to direct ultrasonic energy toward a welding specimen to generate ultrasonic energy to be sensed by one or more sensors, said one or more sensors being located on an opposing side of a weld seam from the ultrasonic energy source.

15. The method of claim 10, wherein the error compensation model is at least partially dependent upon wire feed rate of a welder.

16. The method of claim 10, further comprising analyzing a previously welded specimen to determine actual, off-line time of flight data and using said off-line time of flight data to generate the error compensation model.

17. An in-process welding device to compensate for error associated with detected weld penetration depth, the device comprising:
a welding station comprising a welding specimen, a welding torch, an ultrasonic energy source, and an ultrasonic energy transducer, the welding specimen having a welding seam for joining a first specimen and a second specimen;
the ultrasonic energy source being disposed to emit ultrasonic energy toward the first specimen for creating a wave energy that travels through the welding seam toward the second specimen;
the ultrasonic energy transducer being disposed to sense the wave energy traveling through the second specimen; and
a controller, operatively coupled to the ultrasonic energy transducer, configured to compare sensed wave energy to error compensation data and in response to said comparison adjust welding parameters in the dynamic welding environment.

18. The device of claim 17, wherein the error compensation data is based on a nuero-fuzzy error compensation model.

19. The device of claim 17, wherein the controller is further configured to compare the sensed wave energy to error compensation data to determine estimated time of flight data for use in estimating weld penetration depth.

20. The device of claim 17, wherein the controller is further configured to determine an estimated weld penetration depth of the weld seam based on the error compensation model.
